(19) United States
(12) Patent Application Publication
(10) Pub. No.: US 2026/0132008 A1
(43) Pub. Date: May 14, 2026

(54) AUGMENTED LIDAR (LIGHT DETECTION AND RANGING) BOUNDARIES FOR AUTONOMOUS MOBILE ROBOT ROUTING

(71) Applicant: INTERNATIONAL BUSINESS MACHINES CORPORATION, ARMONK, NY (US)

(72) Inventors: Joseph Scaglione, Poughkeepsie, NY (US); RYAN ELSASSER, Salt Point, NY (US); Schuyler Mann, Poughkeepsie, NY (US); Daniel Ruiz, Cold Spring, NY (US)

(21) Appl. No.: 18/944,367

(22) Filed: Nov. 12, 2024

(51) Int. Cl. B66F 9/075; B66F 9/06; G01S 17/89; G05D 1/622; G05D 105/20; G05D 111/10

(52) U.S. Cl. CPC B66F 9/0755; B66F 9/063; G01S 17/89; G05D 1/637; G05D 2105/20; G05D 2111/17

(57) ABSTRACT

Techniques are disclosed where LIDAR (Light Detection and Ranging) boundaries are augmented for routing an autonomous mobile robot. LIDAR sensors on an autonomous mobile robot (AMR) detect multiple surfaces on a device coupled to an object. The detecting of the multiple surfaces by the LIDAR sensors creates a pattern recognizable by the LIDAR sensors. The pattern is recognized using a program of a computer communicating with the LIDAR sensors and the AMR. Using the computer, the pattern is translated into a boundary message including instructions for generating an artificial buffer for the AMR.

### BACKGROUND

The present disclosure relates to detecting and generating LIDAR (Light Detection and Ranging) boundaries for an autonomous mobile robot (AMR) for route planning and implementation.

In one example, Autonomous Mobile Robots (AMRs) primarily use LIDAR (light detection & ranging) sensors to determine the presence of obstacles and their position/orientation on a map. LIDAR sensors are typically safety-rated sensors on an AMR. Other sensors can influence route planning but cannot trigger a robot protective stop. The LIDAR sensors create a 2D (two-dimensional) point cloud at a fixed height off the ground (for example, ˜7 inches). LIDAR sensors may not detect protruding (for example, cantilevered) obstacles above or below a fixed height because of their 2D nature. Fixed protruding objects (such as shelves) can be avoided with map settings, but dynamic protruding obstacles (such as forklift trucks, and mobile lifts, which have variable lifting platforms) are difficult to detect and avoid.

### SUMMARY

The present disclosure recognizes the shortcomings and problems associated with LIDAR boundaries for routing autonomous mobile robots.

The present invention provides a solution for LIDAR sensors to detect protruding (for example, cantilevered forklifts, or variable lifting platforms) obstacles above or below a fixed height because of their 2D nature. For example, obstacles protruding horizontally and in a parallel plane to the floor that an AMR is traversing, and which may not be in a LIDAR scan zone of the AMR. Such an obstacle my be dynamic, for example, a mobile lift which can change protruding forks in a vertical direction which thereby can enter and leave a scan zone. The solution according to the present invention includes detecting a device attached to, for example, a mobile lift, where the LIDAR sensor of the AMR detect multiple distance enabled by the device and generates a boundary radius for the AMR based on the multiple distances.

In an aspect according to the present invention, a method for augmenting LIDAR (Light Detection and Ranging) boundaries for routing an autonomous mobile robot including detecting, using LIDAR sensors on an autonomous mobile robot (AMR), a first surface and a second surface on a device coupled to an object. The detecting of the first surface and the second surface by the LIDAR sensors creating a pattern recognizable by the LIDAR sensors. The method includes recognizing the pattern using a program of a computer communicating with the LIDAR sensors and the AMR. Using the computer, the pattern into a boundary message including instructions for generating an artificial buffer for the AMR. The method includes generating the artificial buffer for the AMR, using the computer, with reference to the device, when the computer of the AMR detects the pattern using the LIDAR sensors.

In a related aspect, the method further including instructing, using the computer, the AMR to avoid the artificial buffer when the AMR is in motion.

In a related aspect, the program adjusts the artificial buffer in response to the pattern.

In a related aspect, the device includes an adjustable surface as the second surface, and the adjustable surface is used to alter distance readings of the LIDAR sensors with respect to the first surface, in concert with adjustment of the adjustable surface; and the method further comprising. The method includes detecting, using the LIDAR sensors, the first surface and the adjustable surface as the second surface to detect the pattern, and generating the artificial buffer based on the pattern.

In a related aspect, the adjustable surface is adjustable manually or electromechanically.

In a related aspect, the adjustable surface is dynamically adjustable over a period of time; and the method further includes detecting, using the LIDAR sensors, the adjustable surface over the period of time to recognize the pattern. The method includes translating the patterns into the boundary message including the instructions for generating the artificial buffer based on the pattern detected from the adjustable surface and the first surface.

In a related aspect, the device includes a rotating cone in an interior cavity, and the rotating cone includes notches as the second surfaces, the rotating cone is adjustable to alter distance readings of the LIDAR sensors with respect to the first surface and the second surface produced by the notches, in concert with adjustment of the rotating cone. The method further includes detecting, using the LIDAR sensors, the first surface and the second surface produced by the notches to detect the pattern, and generating the artificial buffer based on the pattern.

In a related aspect, each of the distance readings corresponding to respective settings of the rotating cone is recognized by the computer interpreting LIDAR sensor readings as a corresponding pattern, and each of the corresponding patterns instructs the AMR to create, using the computer, a respective artificial buffer.

In a related aspect, the rotating cone includes a plurality of notches as the second surfaces and is rotatable to create a dynamic pattern over a time period. And the method further includes receiving the dynamic pattern over the time period at the computer communicating with the LIDAR sensors when the rotating cone is rotated to generate the dynamic pattern over the time period. The method includes interpreting the dynamic pattern, using the computer, to generate the artificial buffer.

In another aspect according to the present invention, a computer system for augmenting LIDAR (Light Detection and Ranging) boundaries for routing an autonomous mobile robot includes a processor set, a computer-readable storage medium, and program instructions stored on the computer-readable storage medium to cause the processor set to perform operations as follows. The computer system includes detecting, using LIDAR sensors on an autonomous mobile robot (AMR), a first surface and a second surface on a device coupled to an object, the detecting of the first surface and the second surface by the LIDAR sensors creating a pattern recognizable by the LIDAR sensors. Operations include recognizing the pattern using a program of a computer communicating with the LIDAR sensors and the AMR. Operations include translating, using the computer, the pattern into a boundary message including instructions for generating an artificial buffer for the AMR. Operations include generating the artificial buffer for the AMR, using the computer, with reference to the device, when the computer of the AMR detects the pattern using the LIDAR sensors.

In a related aspect, the computer system further includes instructing, using the computer, the AMR to avoid the artificial buffer when the AMR is in motion.

In a related aspect, the program adjusts the artificial buffer in response to the pattern.

In a related aspect, the device includes an adjustable surface as the second surface, and the adjustable surface is used to alter distance readings of the LIDAR sensors with respect to the first surface, in concert with adjustment of the adjustable surface. The computer system further includes detecting, using the LIDAR sensors, the first surface and the adjustable surface as the second surface to detect the pattern, and generating the artificial buffer based on the pattern.

In a related aspect, the adjustable surface is adjustable manually or electromechanically.

In a related aspect, the adjustable surface is dynamically adjustable over a period of time; and the computer system further includes detecting, using the LIDAR sensors, the adjustable surface over the period of time to recognize the pattern. The computer system translating the patterns into the boundary message including the instructions for generating the artificial buffer based on the pattern detected from the adjustable surface and the first surface.

In a related aspect, the device includes a rotating cone in an interior cavity, and the rotating cone includes notches as the second surfaces. The rotating cone is adjustable to alter distance readings of the LIDAR sensors with respect to the first surface and the second surface produced by the notches, in concert with adjustment of the rotating cone. The computer system further includes detecting, using the LIDAR sensors, the first surface and the second surface produced by the notches to detect the pattern, and generating the artificial buffer based on the pattern.

In a related aspect, each of the distance readings corresponding to respective settings of the rotating cone is recognized by the computer interpreting LIDAR sensor readings as a corresponding pattern, and each of the corresponding patterns instructs the AMR to create, using the computer, a respective artificial buffer.

In a related aspect, the rotating cone includes a plurality of notches as the second surfaces and is rotatable to create a dynamic pattern over a time period. The computer system includes receiving the dynamic pattern over the time period at the computer communicating with the LIDAR sensors when the rotating cone is rotated to generate the dynamic pattern over the time period, and interpreting the dynamic pattern, using the computer, to generate the artificial buffer.

In another aspect according to the present invention, a computer program product for augmenting LIDAR (Light Detection and Ranging) boundaries for routing an autonomous mobile robot includes, a computer readable storage medium having program instructions embodied therewith, to perform the following operations. The computer program product includes detecting, using LIDAR sensors on an autonomous mobile robot (AMR), a first surface and a second surface on a device coupled to an object. The detecting of the first surface and the second surface by the LIDAR sensors creating a pattern recognizable by the LIDAR sensors. An operation includes recognizing the pattern using a program of a computer communicating with the LIDAR sensors and the AMR. The operation includes translating, using the computer, the pattern into a boundary message including instructions for generating an artificial buffer for the AMR. The operation includes generating the artificial buffer for the AMR, using the computer, with reference to the device, when the computer of the AMR detects the pattern using the LIDAR sensors.

In a related aspect, the computer program further includes instructing, using the computer, the AMR to avoid the artificial buffer when the AMR is in motion.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1A is an isometric view of a mechanical assembly having a semicircular casing with slits, for augmenting LIDAR boundaries for routing an autonomous mobile robot.

FIG. 1B is a side elevational cross-sectional view (along line AA shown in FIG. 1A) of the mechanical assembly shown in FIG. 1A depicting an adjustable cone.

FIG. 2A is a side elevational view of a forklift truck, depicting horizontally extending forks, and the mechanical assembly mounted on the forklift truck, interacting with an autonomous mobile robot.

FIG. 2B is a plan view of the forklift shown in FIG. 2A.

FIG. 3A is cross sectional plan view of the mechanical assembly depicting first and second surfaces on a circular cone detectable by LIDAR sensors.

FIG. 3B is cross sectional plan view of the mechanical assembly depicting first and second surfaces on a circular cone resulting in a detectable pattern by LIDAR sensors and corresponding radiuses.

FIG. 3C is cross sectional plan view of the mechanical assembly depicting first and second surfaces on the circular cone detectable by LIDAR sensors which identify patterns and depicting calculated boundaries based on the pattern detected by the LIDAR sensors.

FIG. 4A is an isometric view of the inside of the mechanical assembly shown in FIG. 1A depicting a rotating cone having notches.

FIG. 4B is an isometric view of the mechanical assembly as shown in FIG. 1A depicting a DC (Direct Current) motor connected to a microcontroller communicating with the rotating cone shown in FIG. 4A.

FIG. 5 is a schematic diagram depicting a protocol communication using binary code in sequence.

FIG. 6 is a flow chart depicting a method for augmenting LIDAR (Light Detection and Ranging) boundaries for routing an autonomous mobile robot.

FIG. 7 is a flow chart depicting an alternative method using the method shown in FIG. 6, for augmenting LIDAR (Light Detection and Ranging) boundaries for routing an autonomous mobile robot.

FIG. 8 is a schematic block diagram depicting a computer system according to an embodiment of the disclosure, which includes cloud computing components and functions, and which can cooperate with the one or more apparatuses, systems, and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method. It is understood that a user can be a customer, an individual, or a group of individuals, or a company or an organization.

LIDAR is an acronym for Light Detection and Ranging. In LIDAR, laser light is sent from a source (transmitter) and reflected from objects in the scene. The reflected light is detected by the system receiver and the time of flight (TOF) is used to develop a distance map of the objects in the scene.

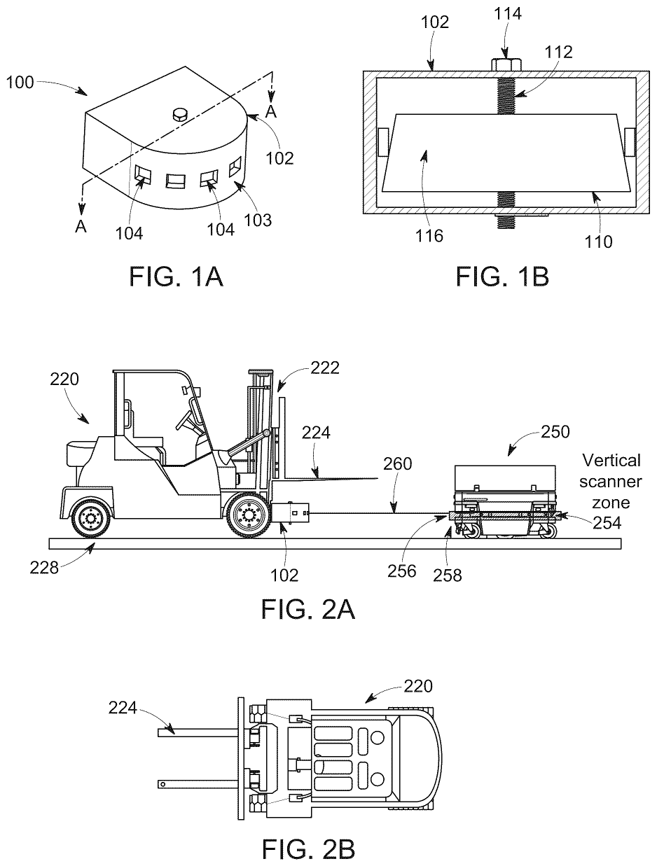

Referring to FIGS. 1A and 1B, in one example, embodiments of the present disclosure can include a system for augmenting LIDAR (Light Detection and Ranging) boundaries for routing an autonomous mobile robot which includes a mechanical assembly 100. The mechanical assembly includes a semicircular casing 102 with slits 104 and an adjustable cone 110 held by a threaded rod 112 and bolt 114.

The height of the cone 110 can be adjusted by turning the threaded rod 112 or alternatively the bolt 114. The mechanical assembly 100 is mounted to protruding objects (such as a fork trucks or mobile lifts, or a mobile lift system) at a similar height as the LIDAR sensors.

Referring to FIGS. 2A and 2B, in one example, a forklift 220 includes a lift mechanism 222 having forks 224. The forklift is mobile on a floor 228. An autonomous mobile robot (AMR) 250 includes LIDAR sensors 260 having a vertical scanner zone 254 with a first measurement 256 from a top plane of the zone to the floor 228, and a second measurement 258 from a bottom plane of the zone to the floor 228, defining the zone 254 itself. The mechanical assembly 100 is mounted to the forklift 220 pointing in the direction of the forks 224 such that the slits 104 are pointed in the direction of the forks.

In operation, LIDAR sensors can detect the casing surface 103 as a surface, and a cone surface 116 of the cone 110 as a second surface which is detected through the slits 104. Depending on the angle of the cone 110, a difference measurement between the distance measurement between the two readings, the LIDAR distance reading to the first surface and the LIDAR distance reading to the second surface, can be calculated as a signal, and in sequence as the LIDAR sensor scan, as a pattern. The pattern can be defined as a signal to the AMR to generate a boundary with respect to the mechanical assembly 100 based on the pattern. For example, a difference measurement can in itself be a signal to generate a boundary around or from (or with respect to) the mechanical assembly, or a series of difference measurements, or a sequence of difference measurements, can be defined as a pattern which signal the AMR to generate a boundary with respect to the mechanical assembly 100.

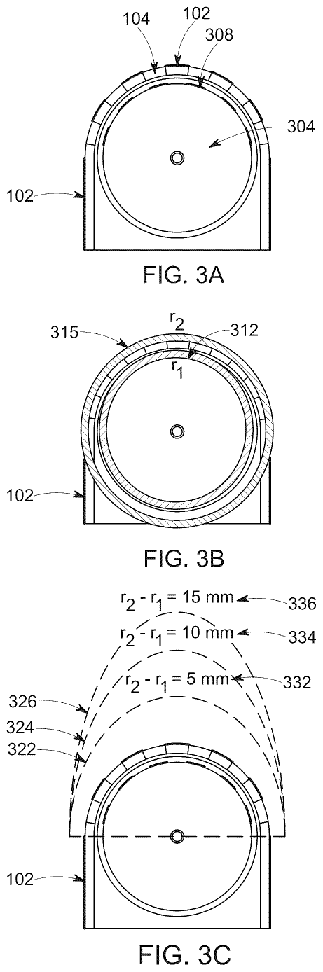

Referring to FIGS. 3A, 3B and 3C, in one embodiment of the present disclosure, the casing 102 of the mechanical assembly 100 provides a first surface for the AMR LIDAR sensors as in previous examples. The interior of the casing 102 includes a circular cone 304 which provides surfaces 308 through the slits 104 for detection by the AMR LIDAR sensors, and the surfaces 308 can also be referred to as second surfaces. In operation, the AMR LIDAR sensors perceive both the casing 102 as a first surface and the second surfaces 308 of the circular cone 304 (through the slits 104). The LIDAR sensors create a 2D (Two Dimensional) point cloud at a fixed height off the ground. The LIDAR sensors can detect both the first surface at different points or parts of the casing 102 and the second surfaces thereby detecting two radiuses with respect to the mechanical assembly 100. The LIDAR detection thus creates two concentric, semicircular outlines, for example, radius 1 (r₁) 312 and radius 2 (r₂) 315 as shown in FIG. 3B. The semicircular outlines, which can also be referred to as a pattern, can be used to algorithmically instruct the robot to create an artificial buffer with respect to the pattern that the robot will avoid. A pattern detection algorithm can recognize concentric semi-circles and can determine the difference in radii.

For example, referring to FIG. 3C, in a first equation 332 where r₂−r₁ is equal to a 5 mm a first buffer 322 is implemented. In a second equation 334, where r₂−r₁ is equal to 10 mm, a second buffer 324 is implemented. In a third equation 336, where r₂−r₁ is equal to 15 mm, a third buffer 326 is implemented. An AMR navigation planner can assign an augmented keep-out zone proportional to the difference in radii.

A pattern is distinct, such that it will not be triggered by other common obstacles. For example, the patterns can be a detected 2D region that the robot should avoid. The size of the 2D region to avoid can be adjusted by moving the cone up or down within the casing, which generates different radius difference calculation, and thereby can be used as a code and/or translated to a calculated boundary from the first surface or the second surface.

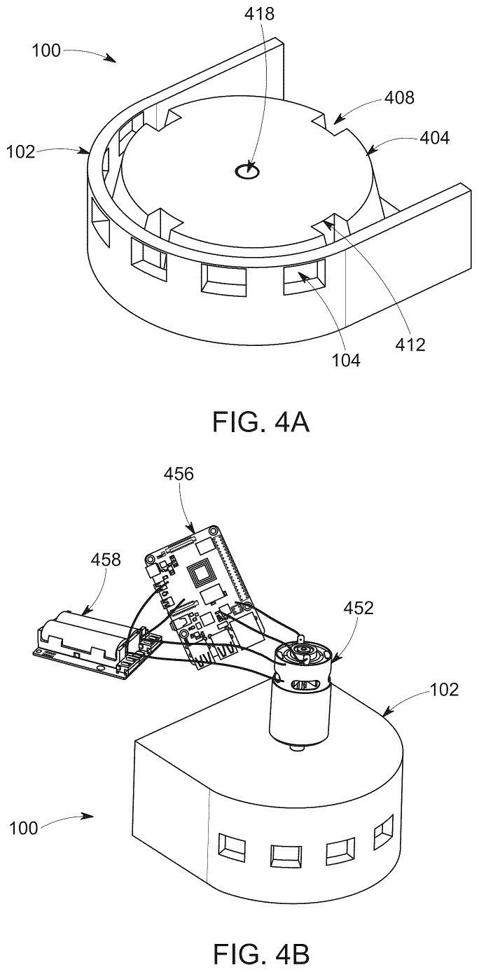

Referring to FIG. 4A, in another embodiment according to the present disclosure, the casing 102 of the mechanical assembly 100 provides a first surface for the AMR LIDAR sensors as in previous examples. The interior of the casing 102 includes a rotating cone 404 having notches 408 which provides notch surfaces 412 through the slits 104 for detection by the AMR LIDAR sensors, and the notch surfaces 412 can also be referred to as second surfaces according to this embodiment.

In operation, the AMR LIDAR sensors perceive both the casing 102 as a first surface and notch surfaces 412 of the notch 408 as second surfaced of the rotating cone 404 (through the slits 104). The LIDAR sensors can detect both the first surface at different points or parts of the casing 102 and the second surfaces as the notch surfaces 412, thereby detecting a pattern depending on the rotation speed of the rotating cone. The pattern can be used to algorithmically instruct the robot to create an artificial buffer, with respect to the pattern, that the robot will avoid. For example, a pattern detection algorithm can recognize different patterns detected by the LIDAR sensors with respect to the speed of rotation of the rotating cone and the first surface provided by the casing 102.

The rotating cone 404 includes notches 408, or also can be referred to as keyed or as a rotating keyed cone, and rotates around an axis 418 at a certain rate to convey additional data/instructions. Thus, instead of a static pattern, the pattern can change over time, and can convey additional information depending on a translation of the patterns by an AMR computer communicating with the LIDAR sensors. Such a translation can include buffer dimension with reference to the casing, or video or pictures.

In one example the cone can be rotated at a speed proportional to the speed of a fork truck it is mounted to, and thus the AMR can understand how fast the fork truck is moving by interpreting a pattern which relates the speed of the fork truck. This could be used to create a keep out zone proportional in size to the speed of the fork truck to account for an appropriate braking distance.

Referring to FIG. 4B, in another example, the casing 102 is shown with the rotating cone 404 shown in FIG. 4A inside the casing. A microcontroller 456 can trigger a DC (Direct Current) motor 452 to spin the rotating cone 404 at varying rates (such as RPM (revolutions per minute) and/or pulses (such as ON/OFF) to convey more information than a static pattern. In this manner, a communication protocol can communicate with LIDAR sensors. The DC motor can be connected to a microcontroller 456 which includes a timer circuit. A battery pack 458 can power the DC motor and the microcontroller.

For example, each spin or rotation or absence of spin or rotation of the rotating cone 404 during a given time could represent a bit (binary 0 or 1). Lidar sensors can shoot millions of laser pulses per second, allowing for fast data transmission. For example, in operation, a rotating cone 404, rotating at a specified speed, is received as a specific pattern to the AMR LIDAR sensors, with respect to the speed of rotation and the placement of the notches 408 and notch surfaces 412. Multiple choices of variations in rotation speed and notch surfaces can accommodate many patterns, and thus be translated to associated messages once received by the LIDAR sensors. The computer communicating with the LIDAR sensors and AMR can translate the specific pattern as a message to the AMR which can include boundary parameters with respect to the assembly 100. The computer can communicate the message, i.e., the boundary parameters to the AMR.

One advantage of the rotating cone is the flexibility and multiplicity of patterns that can be generated, and thus messages to the AMR.

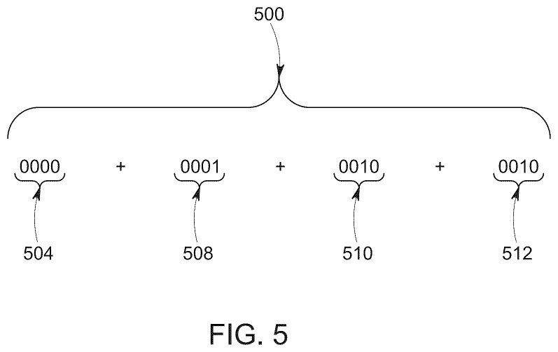

Referring to FIG. 5, in one example, a pattern 500 received by the LIDAR sensors by detecting the assembly 100 with the rotating cone 404 and can include a series of binary numbers where each group of four numbers is a section of the pattern and each section represents a sub-category of the pattern. A first series of binary numbers in the pattern can indicate a new message 504. The first series of binary numbers, that is, the first series of four consecutive blank pulses can be used to convey the beginning of a new transmission.

A second series of binary numbers in the pattern can indicate an object class 508. The second series of binary numbers which are the following four pulses of the first series of binary numbers, can be used to transmit the object class (e.g., moving vehicle, static obstacle, road sign, etc.).

A third series of binary numbers in the pattern can indicate an object type 510. The third series of binary numbers, the next four pulses, can transmit the type of object specified in that class (e.g., SUV, sedan, truck, emergency vehicle, etc.).

A fourth series of binary numbers in the pattern can indicate an object information 512 (e.g., a type or value). Additional pulses can be used to transmit more information about the object (e.g., speed—40 mph, color—red, etc.).

In the embodiment of the present disclosure discussed above, instead of an assembly that is manually set and conveys a single piece of information, this alternative embodiment allows additional/changing information to be communicated. In another example, a smart IOT (Internet of Things) controller can change or recommend a speed of the AMR which can be based on weather conditions, altering routes based on time of day, managing traffic flow, etc., by changing the pattern generated by the rotating cone.

### Further Embodiments and Examples

The embodiments of the present disclosure, for example, can use a mechanical assembly as discussed above to allow recognition of unseen obstacles that are not connected to a robot's fleet software and to change its operating procedure based on the presence of these assemblies. In one example, a mechanical assembly can be added to movable/temporary cantilevered equipment, and minimizes the amount of data managed by a fleet management system. In another embodiment the use of a distinct physical 2D pattern and one or more LIDAR sensors to transmit instructions to a mobile processing unit. Instructions can include a 2D region to avoid, location/orientation information, or instructions to execute an action. In another example, the use of two concentric, semi-circular objects, where one of the objects moves to create the distinct physical 2D pattern can be used. Moving the object alters the instructions that are interpreted by an image recognition algorithm. In another example, the use of a variable surface profile with an active control system for the purpose of conveying lidar data can include a modulating rotational speed on a keyed cone(s) to convey data over time (e.g. a rotating keyed cone). The modulating cone height can be perpendicular to a plane of sensing to convey data over time. In another example, modulating surface profile variations on a rotating cylinder can convey data over time, for example, a cylinder with a plurality of protuberances and/or grooves or notches, can be rotated and the speed varied to alter a pattern received by the LIDAR sensors. In another example, modulating space between a series of stacked discs perpendicular to a plane of sensing can convey data over time, and such a data transmission methodology is decoupled from rotation.

### Additional Embodiments and Examples

Embodiments of the present disclosure can use LIDAR sensors to detect a pattern from a device or mechanical assembly to convey a message for boundary instructions for an AMR. Such embodiments provide techniques for detecting multiple surfaces for interpretation as a pattern that is translated to a boundary message for the AMR, thus the avoidance boundary for the AMR is derived from the pattern and the message it provides rather than a direct detection of an object and avoiding the object.

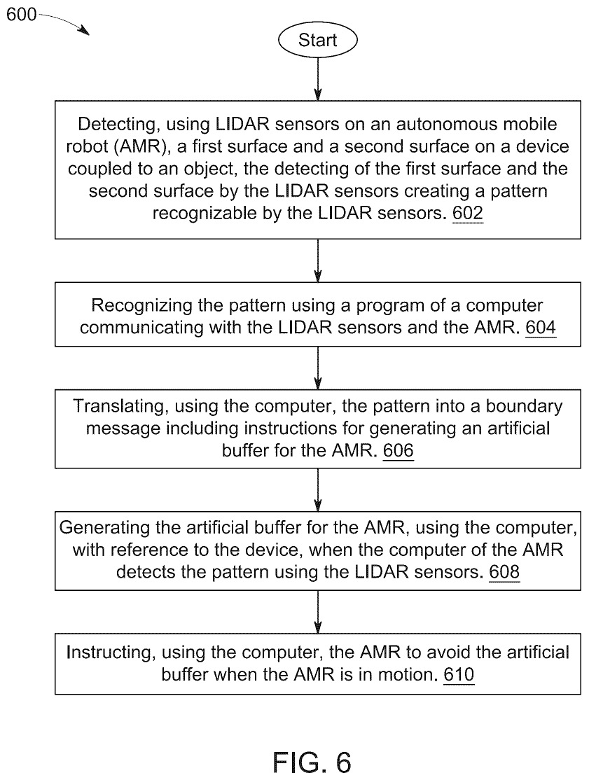

Referring to FIG. 6, and in one embodiment according to the present disclosure, and with reference to the embodiments shown in FIGS. 1A, 1B, 2A, 2B, 3A, 3B, 4A, 4B, a method 600 for augmenting LIDAR (Light Detection and Ranging) boundaries for routing an autonomous mobile robot includes the following functions. The method 600 includes detecting, using LIDAR sensors 260 on an autonomous mobile robot (AMR) 250, as in operation 602. A casing surface 103 is embodied as a first surface and a cone surface 116 is embodied as a second surface on a device embodied as the mechanical assembly 100 coupled to an object embodied as a forklift 220, as in operation 602. The detecting of the first surface and the second surface by the LIDAR sensors creating a pattern recognizable by the LIDAR sensors, as in operation 602.

The method 600 includes recognizing the pattern using a program of a computer communicating with the LIDAR sensors and the AMR, as in operation 604.

The method 600 includes translating, using the computer, the pattern into a boundary message including instructions for generating an artificial buffer for the AMR, as in operation 606.

The method 600 includes generating the artificial buffer for the AMR, using the computer, with reference to the device, when the computer of the AMR detects the pattern using the LIDAR sensors, as in operation 608. The computer can be used to instruct the AMR using the program of the computer communicating with the LIDAR sensors to create the artificial buffer based on the pattern.

In one example, the method 600 includes instructing, using the computer, the AMR to avoid the artificial buffer when the AMR is in motion, as in operation 610.

In one example, the program can adjust the artificial buffer in response to the pattern or a recognized pattern.

In another embodiment, the device can include an adjustable surface as the second surface. The adjustable surface can be used to alter distance readings of the LIDAR sensors with respect to the first surface, in concert with adjustment of the adjustable surface. The method can further includes detecting, using the LIDAR sensors, the first surface and the adjustable surface as the second surface to detect the pattern, and generating the artificial buffer based on the pattern.

In another example, the adjustable surface is adjustable manually or electromechanically, that is, using actuation which is manually initiated or electromechanically initiated. In a further example, the adjustable surface can be adjusted using hydraulic actuation or pneumatic actuation.

In another example, the adjustable surface can be dynamically adjustable over a period of time. The method can further include detecting, using the LIDAR sensors, the adjustable surface over the period of time to recognize the pattern. And the method can include translating the patterns into the boundary message including the instructions for generating the artificial buffer based on the pattern detected from the adjustable surface and the first surface.

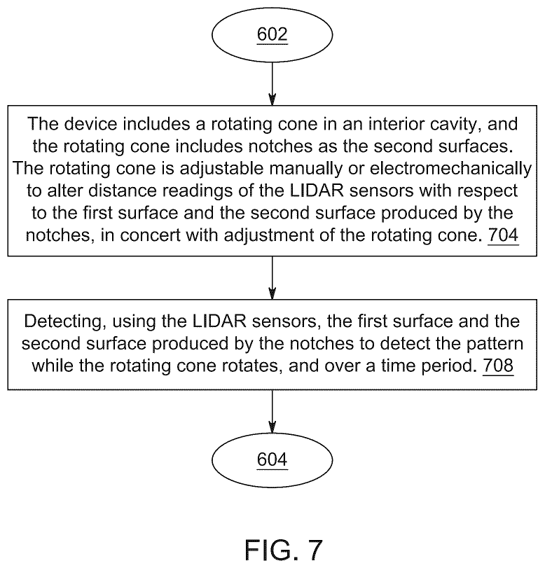

In another embodiment according to the present disclosure, the device can include a rotating cone in an interior cavity, and the rotating cone includes notches as the second surfaces. The rotating cone is adjustable to alter distance readings of the LIDAR sensors with respect to the first surface and the second surface produced by the notches, in concert with adjustment of the rotating cone, as in operation 704 shown in FIG. 7. The rotating cone can be actuated for adjustment, for example, manually or electromechanically, and alternatively, hydraulically or pneumatically. The method further includes detecting, using the LIDAR sensors, the first surface and the second surface produced by the notches to detect the pattern while the rotating cone rotates, as in operation 708, and generating the artificial buffer based on the pattern.

In another example, each of the distance readings correspond to respective settings of the adjustable cone and are recognized by the computer interpreting LIDAR sensor readings as a corresponding pattern. Each of the corresponding patterns instructs the AMR to create, using the computer, a respective artificial buffer.

In another example, the rotating cone includes a plurality of notches as the second surfaces and is rotating to create a dynamic pattern over a time period. The method further includes receiving the dynamic pattern over the time period at the computer communicating with the LIDAR sensors when the adjustable cone is rotated to generate the dynamic pattern over the time period, and interpreting the dynamic pattern, using the computer, to generate the artificial buffer.

In another embodiment according to the present disclosure, a computer system for augmenting LIDAR (Light Detection and Ranging) boundaries for routing an autonomous mobile robot can include a processor set, a computer-readable storage medium, and program instructions stored on the computer-readable storage medium to cause the processor set to perform the following operations. An operation includes detecting, using LIDAR sensors on an autonomous mobile robot (AMR), a first surface and a second surface on a device coupled to an object, the detecting of the first surface and the second surface by the LIDAR sensors creating a pattern recognizable by the LIDAR sensors. Another operation includes recognizing the pattern using a program of a computer communicating with the LIDAR sensors and the AMR. Another operation includes translating, using the computer, the pattern into a boundary message including instructions for generating an artificial buffer for the AMR. Another operation includes generating the artificial buffer for the AMR, using the computer, with reference to the device, when the computer of the AMR detects the pattern using the LIDAR sensors.

In another embodiment according to the present disclosure, a computer program product for augmenting LIDAR (Light Detection and Ranging) boundaries for routing an autonomous mobile robot can include a computer readable storage medium having program instructions embodied therewith, to perform the following operations. An operation includes detecting, using LIDAR sensors on an autonomous mobile robot (AMR), a first surface and a second surface on a device coupled to an object, the detecting of the first surface and the second surface by the LIDAR sensors creating a pattern recognizable by the LIDAR sensors. Another operation includes recognizing the pattern using a program of a computer communicating with the LIDAR sensors and the AMR. Another operation includes translating, using the computer, the pattern into a boundary message including instructions for generating an artificial buffer for the AMR. Another operation includes generating the artificial buffer for the AMR, using the computer, with reference to the device, when the computer of the AMR detects the pattern using the LIDAR sensors.

Embodiment of the present disclosure include an apparatus for augmenting LIDAR boundaries for an autonomous mobile robot routing which includes a first surface and a second surface on a device couplable to an object in a workspace and which is detectable by an autonomous mobile robot (AMR) having LIDAR sensors for detecting objects. The first surface and the second surface creating a pattern detectable or readable by the LIDAR sensors. The pattern is recognizable by a program of a computer communicable with the LIDAR sensors. When the AMR detects the pattern using the LIDAR sensors, the program of the computer instructs the AMR to create an artificial buffer around the pattern such that the AMR avoids the artificial buffer when the AMR is in motion by recognizing the artificial buffer.

Embodiment of the present disclosure include a system for augmenting LIDAR boundaries for an autonomous mobile robot routing which includes the following. The system includes an autonomous mobile robot (AMR) having LIDAR sensors for detecting objects. A first surface and a second surface on a device are coupled to one of the objects. The device is detectable by the LIDAR sensors and creates a pattern for the LIDAR sensors when detected. The pattern is recognizable by a program of a computer communicable with the LIDAR sensors. When the AMR detects the pattern using the LIDAR sensors, the program of the computer instructs the AMR to create an artificial buffer around the pattern such that the AMR, when in motion, avoids the artificial buffer.

Embodiment of the present disclosure include a method for augmenting LIDAR boundaries for an autonomous mobile robot routing which includes the following. The method includes receiving, at a computer communicating with LIDAR sensors of an autonomous mobile robot (AMR), detection, using the LIDAR sensors, of a first surface and a second surface on a device coupled to an object. The detecting of the first surface and the second surface by the LIDAR sensors creates a pattern recognizable by the LIDAR sensors. The method includes recognizing the pattern using a program of the computer communicating with the LIDAR sensors. When the computer of the AMR detects the pattern using the LIDAR sensors, instructing the AMR using the program of the computer communicating with the LIDAR sensors, to create an artificial buffer around the pattern, thereby the AMR avoiding the artificial buffer when the AMR is in motion.

Embodiment of the present disclosure include a method for augmenting LIDAR boundaries for an autonomous mobile robot routing which includes the following. The method includes an LIDAR sensors of an AMR scanning an area and receiving, at a computer communicating with the LIDAR sensors of the AMR, detection, using the LIDAR sensors, of a first surface and a second surface on a device coupled to an object. The detecting of the first surface and the second surface by the LIDAR sensors creates a pattern recognizable by the LIDAR sensors. The method includes recognizing the pattern using a program of the computer communicating with the LIDAR sensors. When the computer of the AMR detects the pattern using the LIDAR sensors, instructing the AMR using the program of the computer communicating with the LIDAR sensors, to create an artificial buffer around the pattern. The AMR avoiding the artificial buffer when the AMR is in motion.

Embodiment of the present disclosure include a method for augmenting LIDAR boundaries for an autonomous mobile robot routing which includes the following. The method includes detecting, using lidar sensors on an autonomous mobile robot (AMR), a first surface and a second surface on a device coupled to an object, the detecting of the first surface and the second surface by the LIDAR sensors creating a pattern recognizable by the LIDAR sensors. The method includes recognizing the pattern using a program of a computer communicating with the LIDAR sensors. When the computer of the AMR detects the pattern using the LIDAR sensors, instructing the AMR using the program of the computer communicating with the LIDAR sensors to create an artificial buffer around the pattern; and the AMR avoiding the artificial buffer when the AMR is in motion.

In one example, the program adjusts the artificial buffer in response to the recognized pattern. In another example, the device includes an adjustable cone in an interior cavity which is adjusted manually or electromechanically to alter distance readings of the LIDAR sensors with respect to the first surface and the second surface, in concert with adjustment of the adjustable cone. In another example, each of the distance readings corresponding to respective settings of the adjustable cone is recognized by the computer interpreting LIDAR sensor readings as a distinct pattern and each distinct pattern instructs the AMR to create, using the computer, a corresponding artificial buffer.

In another embodiment, an apparatus for augmenting LIDAR boundaries for an autonomous mobile robot routing can include, a first surface and a second surface on a device couplable to an object in a workspace and being detectable by an autonomous mobile robot (AMR) having LIDAR sensors for detecting objects. The first surface and the second surface create a pattern detectable or readable by the LIDAR sensors. The pattern is recognizable by a program of a computer communicable with the LIDAR sensors. When the AMR detects the pattern using the LIDAR sensors, the program of the computer instructs the AMR to create an artificial buffer around the pattern such that the AMR avoids the artificial buffer when the AMR is in motion by recognizing the artificial buffer.

In another embodiment, a system for augmenting LIDAR boundaries for an autonomous mobile robot routing can include an autonomous mobile robot (AMR) having LIDAR sensors for detecting objects. A first surface and a second surface on a device are coupled to one of the objects, and the device is detectable by the LIDAR sensors and creates a pattern for the LIDAR sensors when detected. The pattern is recognizable by a program of a computer communicable with the LIDAR sensors. When the AMR detects the pattern using the LIDAR sensors, the program of the computer instructs the AMR to create an artificial buffer around the pattern such that the AMR, when in motion, avoids the artificial buffer.

In another embodiment, a method for augmenting LIDAR (Light Detection and Ranging) boundaries for an autonomous mobile robot routing includes receiving, at a computer communicating with LIDAR sensors of an autonomous mobile robot (AMR), detection, using the LIDAR sensors, of a first surface and a second surface on a device coupled to an object. The detecting of the first surface and the second surface by the LIDAR sensors creating a pattern recognizable by the LIDAR sensors. The method includes recognizing the pattern using a program of the computer communicating with the LIDAR sensors. When the computer of the AMR detects the pattern using the LIDAR sensors, instructing the AMR using the program of the computer communicating with the LIDAR sensors, to create an artificial buffer around the pattern, thereby the AMR avoiding the artificial buffer when the AMR is in motion.

### Other Examples and Embodiments

In another example, a computer used for communication with the AMR can be part of a mobile device. The computer can include a processor and a computer readable storage medium where an application can be stored which can in one example, embody all or part of the method of the present disclosure. The application can include all or part of instructions to implement the method of the present disclosure, embodied in code and stored on a computer readable storage medium. The device can include a display. The device can operate, in all or in part, in conjunction with a remote server by way of a communications network, for example, the Internet.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

Referring to one or more embodiments in the figures, a computer or a device communicating with the AMR, also can be referred to as a user device or an administrator's device, can include a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet. It is understood that the user device is representative of similar devices which can be for other users, as representative of such devices, which can include, mobile devices, smart devices, laptop computers etc.

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items. In one example a user can register and have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business. Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

### Other Additional Embodiments and Examples

An Artificial Intelligence (AI) System can include machines, computer, and computer programs which are designed to be intelligent or mirror intelligence. Such systems can include computers executing algorithms. AI can include machine learning and deep learning. For example, deep learning can include neural networks. An AI system can be cloud based, that is, using a cloud-based computing environment having computing resources. In another example, a control system can be all or part of an Artificial Intelligence (AI) system. For example, the control system can be one or more components of an AI system. It is also understood that methods and systems according to embodiments of the present disclosure, can be incorporated into an AI system, and/or components can be part of an AI system. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system.

### More Examples and Embodiments

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

The methods and systems of the present disclosure can include a series of operational blocks for implementing one or more embodiments according to the present disclosure. A method shown in the figures may be another example embodiment, which can include aspects/operations shown in another figure and discussed previously, but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is also understood that the one or more computers or computer systems shown in the figures can include all or part of a computing environment and its components shown in another figure, for example, the computing environment 1000 can be incorporated, in all or in part, in one or more computers or devices, or vice versa, shown in other figures and described herein. In one example, the one or more computers can communicate with all or part of a computing environment and its components as a remote computer system to achieve computer functions described in the present disclosure.

### More Additional Examples and Embodiments

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves opropagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

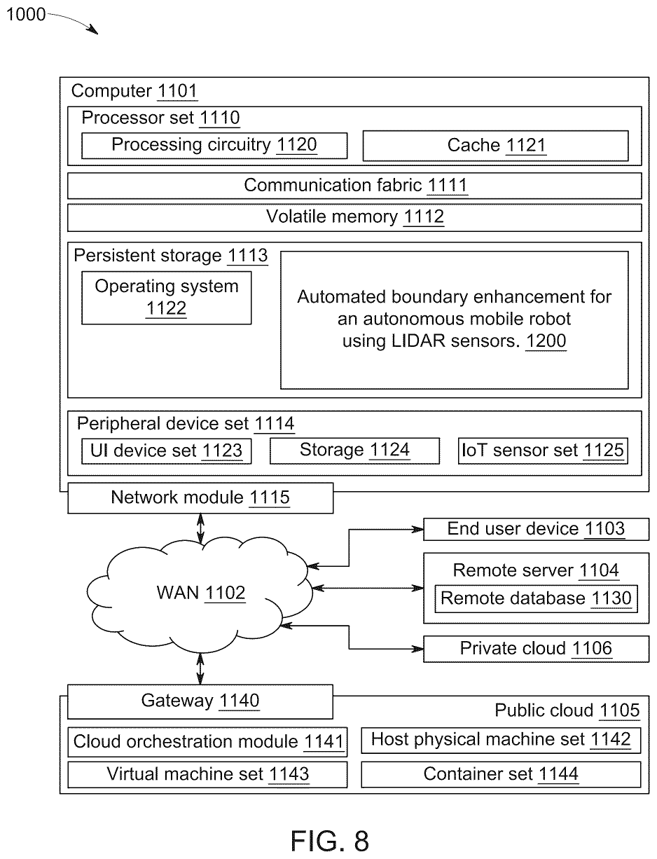

Referring to FIG. 8, a computing environment 1000 contains an example of an environment for the execution of at least some of the computer code involved in performing the inventive methods, such as automated boundary enhancement for an autonomous mobile robot using LIDAR sensors 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1000, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A method for augmenting LIDAR (Light Detection and Ranging) boundaries for routing an autonomous mobile robot, comprising:
detecting, using LIDAR sensors on an autonomous mobile robot (AMR), a first surface and a second surface on a device coupled to an object, the detecting of the first surface and the second surface by the LIDAR sensors creating a pattern recognizable by the LIDAR sensors;
recognizing the pattern using a program of a computer communicating with the LIDAR sensors and the AMR;
translating, using the computer, the pattern into a boundary message including instructions for generating an artificial buffer for the AMR; and
generating the artificial buffer for the AMR, using the computer, with reference to the device, when the computer of the AMR detects the pattern using the LIDAR sensors.

2. The method of claim 1, further comprising:
instructing, using the computer, the AMR to avoid the artificial buffer when the AMR is in motion.

3. The method of claim 1, wherein the program adjusts the artificial buffer in response to the pattern.

4. The method of claim 1, wherein the device includes an adjustable surface as the second surface, and the adjustable surface being used to alter distance readings of the LIDAR sensors with respect to the first surface, in concert with adjustment of the adjustable surface; and the method further comprising:
detecting, using the LIDAR sensors, the first surface and the adjustable surface as the second surface to detect the pattern; and
generating the artificial buffer based on the pattern.

5. The method of claim 4 wherein the adjustable surface is adjustable manually or electromechanically.

6. The method of claim 4, wherein the adjustable surface is dynamically adjustable over a period of time; and the method further comprising:
detecting, using the LIDAR sensors, the adjustable surface over the period of time to recognize the pattern;
translating the patterns into the boundary message including the instructions for generating the artificial buffer based on the pattern detected from the adjustable surface and the first surface.

7. The method of claim 1, wherein the device includes a rotating cone in an interior cavity, and the rotating cone includes notches as the second surfaces, the rotating cone is adjustable to alter distance readings of the LIDAR sensors with respect to the first surface and the second surface produced by the notches, in concert with adjustment of the rotating cone; and the method further comprising:
detecting, using the LIDAR sensors, the first surface and the second surface produced by the notches to detect the pattern; and
generating the artificial buffer based on the pattern.

8. The method of claim 7, wherein each of the distance readings corresponding to respective settings of the rotating cone is recognized by the computer interpreting LIDAR sensor readings as a corresponding pattern, and each of the corresponding patterns instructs the AMR to create, using the computer, a respective artificial buffer.

9. The method of claim 7, wherein the rotating cone includes a plurality of notches as the second surfaces and is rotatable to create a dynamic pattern over a time period; and the method further comprising:
receiving the dynamic pattern over the time period at the computer communicating with the LIDAR sensors when the rotating cone is rotated to generate the dynamic pattern over the time period; and
interpreting the dynamic pattern, using the computer, to generate the artificial buffer.

10. A computer system for augmenting LIDAR (Light Detection and Ranging) boundaries for routing an autonomous mobile robot, comprising:
a processor set, a computer-readable storage medium, and program instructions stored on the computer-readable storage medium to cause the processor set to perform operations comprising:
detecting, using LIDAR sensors on an autonomous mobile robot (AMR), a first surface and a second surface on a device coupled to an object, the detecting of the first surface and the second surface by the LIDAR sensors creating a pattern recognizable by the LIDAR sensors;
recognizing the pattern using a program of a computer communicating with the LIDAR sensors and the AMR;
translating, using the computer, the pattern into a boundary message including instructions for generating an artificial buffer for the AMR; and
generating the artificial buffer for the AMR, using the computer, with reference to the device, when the computer of the AMR detects the pattern using the LIDAR sensors.

11. The computer system of claim 10, further comprising:
instructing, using the computer, the AMR to avoid the artificial buffer when the AMR is in motion.

12. The computer system of claim 10, wherein the program adjusts the artificial buffer in response to the pattern.

13. The computer system of claim 10, wherein the device includes an adjustable surface as the second surface, and the adjustable surface being used to alter distance readings of the LIDAR sensors with respect to the first surface, in concert with adjustment of the adjustable surface; and the computer system further comprising:
detecting, using the LIDAR sensors, the first surface and the adjustable surface as the second surface to detect the pattern; and
generating the artificial buffer based on the pattern.

14. The computer system of claim 13 wherein the adjustable surface is adjustable manually or electromechanically.

15. The computer system of claim 14, wherein the adjustable surface is dynamically adjustable over a period of time; and the computer system further comprising:
detecting, using the LIDAR sensors, the adjustable surface over the period of time to recognize the pattern;
translating the patterns into the boundary message including the instructions for generating the artificial buffer based on the pattern detected from the adjustable surface and the first surface.

16. The computer system of claim 10, wherein the device includes an rotating cone in an interior cavity, and the rotating cone includes notches as the second surfaces, the rotating cone is adjustable manually or electromechanically to alter distance readings of the LIDAR sensors with respect to the first surface and the second surface produced by the notches, in concert with adjustment of the rotating cone; and the computer system further comprising:
detecting, using the LIDAR sensors, the first surface and the second surface produced by the notches to detect the pattern; and
generating the artificial buffer based on the pattern.

17. The computer system of claim 16, wherein each of the distance readings corresponding to respective settings of the rotating cone is recognized by the computer interpreting LIDAR sensor readings as a corresponding pattern, and each of the corresponding patterns instructs the AMR to create, using the computer, a respective artificial buffer.

18. The computer system of claim 17, wherein the rotating cone includes a plurality of notches as the second surfaces and is rotatable to create a dynamic pattern over a time period; and the computer system further comprising:
receiving the dynamic pattern over the time period at the computer communicating with the LIDAR sensors when the rotating cone is rotated to generate the dynamic pattern over the time period; and
interpreting the dynamic pattern, using the computer, to generate the artificial buffer.

19. A computer program product for augmenting LIDAR (Light Detection and Ranging) boundaries for routing an autonomous mobile robot, comprising:
a computer readable storage medium having program instructions embodied therewith, to perform operations comprising:
detecting, using LIDAR sensors on an autonomous mobile robot (AMR), a first surface and a second surface on a device coupled to an object, the detecting of the first surface and the second surface by the LIDAR sensors creating a pattern recognizable by the LIDAR sensors;
recognizing the pattern using a program of a computer communicating with the LIDAR sensors and the AMR;
translating, using the computer, the pattern into a boundary message including instructions for generating an artificial buffer for the AMR; and
generating the artificial buffer for the AMR, using the computer, with reference to the device, when the computer of the AMR detects the pattern using the LIDAR sensors.

20. The computer program product of claim 19, further comprising:
instructing, using the computer, the AMR to avoid the artificial buffer when the AMR is in motion.
